(19) United States
(12) Patent Application Publication
(10) Pub. No.: US 2012/0036209 A1
(43) Pub. Date: Feb. 9, 2012

(54) HIERARCHICAL SOCIAL NETWORK SYSTEM

(75) Inventors: Justin Terrell Lewis, Washington, DC (US); Aharon Riley Wasserman, Washington, DC (US); Edward Saatchi, Washington, DC (US)

(73) Assignee: National Field, LLC, Washington, DC (US)

(21) Appl. No.: 13/179,083

(22) Filed: Jul. 8, 2011

Related U.S. Application Data
(60) Provisional application No. 61/362,417, filed on Jul. 8, 2010.

(51) Int. Cl. G06F 15/16

(52) U.S. Cl. 709/206; 709/204

(57) ABSTRACT

A social network system with an organizational hierarchy established to include a main group with at least one subgroup reporting to the main group. At least one of the one subgroup has field users reporting to the subgroup. Each subgroup has multiple subgroup users while the main group at the apex of the hierarchy has at least one main group user. A server is provided that receives messages from the field users and subgroup users. The field user- and subgroup-messages are communicated to a wireless device associated with the main group user while a first subgroup user receives on a wireless device messages from first subgroup field users on a wireless device. The server employs communication permissions for the organization hierarchy that limit the information to which a member of the organization hierarchy is able to receive based on the role filled by an organization hierarchy member.

### RELATED APPLICATIONS

This application claims priority benefit of U.S. Provisional Application Ser. No. 61/362,417 filed 8 Jul. 2010; the contents of which are hereby incorporated by filed reference.

### BACKGROUND OF THE INVENTION

The flow of information within a hierarchical organization to a decision maker is frustrated by intermediates within the organization. This problem is compounded as the number of layers of intermediates between a decision maker and a field user increase. These forms of frustration of information flow are manifest as a temporal delay as information is communicated within the hierarchy. This information flow frustration also occurs in that intermediates within the hierarchy collect numerous field reports and modify the collected data through compilation and filtration before forwarding summary data upward through the organizational hierarchy. The delays in filtering between a data input into an organization by a field user to an apical decision maker within the hierarchical organization represent lost decisional opportunities, especially in highly dynamic environments associated with commercial markets, disaster relief, and political campaigns as exemplary situations. The alternative to a conventional hierarchical information flow upward through an organization are field users directly reporting to the apical decision maker, yet this has proven unworkable by overwhelming a decision maker with excess and non-actionable information.

Efforts to apply social networking system solutions to a hierarchical organization have met with limited success owing to the failure of conventional social networks to distinguish between user hierarchical position between the extreme positions of the newest field user and the organizational apex decision maker. As a result, use of a conventional flat social network in the organizational hierarchy leaves users wasting time wading through irrelevant data to mine information of actionable value to a given user.

Thus, there exists a need for a social network system inclusive of a server with communication capabilities to form a hierarchical social network system that provides users within the hierarchical network actionable information to avoid the temporal bottlenecks and compilation-filtration difficulties associated with a conventional hierarchical organization data flow. There further exists a need for such a hierarchical social network system that filters, organizes, and routes data within the organization in response to data request and usage patterns so as to save individuals within the organization time and therefore make the organization as a whole more productive.

### SUMMARY OF THE INVENTION

A social network system is provided in which an organizational hierarchy is established including a main group that in turn has at least one subgroup reporting to the main group. The at least one subgroup has at least one field user reporting to the subgroup. Each subgroup having multiple subgroup users while the main group at the apex of the hierarchy has at least one main group user. A server is provided that receives messages from wireless devices or mobile web browser directly or via an application programming interface (API) of the field users and subgroup users. The field user messages and subgroup messages are communicated to a wireless device associated with the main group user while a first subgroup user receives on a wireless device messages from first subgroup field users on a wireless device. The server employs preselected communication permissions for the organization hierarchy that limit the information to which a member of the organization hierarchy is able to receive based on the role filled by a given member of the organization hierarchy.

A process of generating compiled graphical output of data comprising: setting up an organizational hierarchy having a main group, the at least one subgroup reporting to the main group, and a plurality of field users reporting to the at least one subgroup, the main group having at least one main group user and the at least one subgroup having a plurality of subgroup users; said plurality of field users inputting at least one field user datum of the data, said member of said plurality of field users lacking permission to access the data other than the at least one field user datum, the at least one field user datum being communicated through a field user wireless device to a server; allowing at least one of the said plurality of subgroup users for said at least one main group user to view the compiled graphical output of data on a secure subgroup user wireless device or a secure main group user wireless device.

### BRIEF DESCRIPTION OF THE DRAWINGS

The present embodiments may be better understood, and numerous features and advantages of the present invention are made apparent to those of skill in the art, with reference to the accompanying drawings.

FIG. 1 is a schematic block diagram illustrating a global software architecture for an inventive hierarchical social network system;

FIG. 2A is a schematic block diagram of three nested hierarchies with respect to a group hierarchy, user hierarchy, and role hierarchy, where the tag table used to create role bundles is designed to tag any kind of object within a database;

FIG. 2B is an organizational chart for a representative hierarchical organization that depicts the various excessive positions as denoted by increasing numerical values;

FIG. 2C is a variant of the organizational chart depicted in FIG. 2B that depicts the process by which another branch of the hierarchy is created as well as depicting the addition of another role within an existing branch;

FIG. 2D is an exemplary dashboard graphical interface for controlling the permissions for the exemplary role 9 of FIG. 2B;

FIG. 3 is a block diagram schematic illustrating the interplay between a system user role and the permissions granted to the user, with such permissions being illustratively action based or object-access based;

FIG. 4A is a block diagram schematic of metrics reported into an inventive hierarchical social network system using a submit report action form;

FIG. 4B is an exemplary user interface for the creation of a qualitative form used to communicate data within the inventive hierarchical social network system;

FIG. 4C is an exemplary user interface for the creation of a qualitative form for use within the inventive hierarchical social network system;

FIG. 4D is an exemplary screen view of settings associated with a qualitative form such as that depicted in FIG. 4B;

FIG. 5 is a block diagram schematic used to assign to a given user or metric a goal value for a given period of time;

FIG. 6 is a schematic block diagram of dynamic ways to collect qualitative information from a report as, for example, generated for a given report category as detailed with respect to FIG. 4;

FIG. 7 is a schematic block diagram of a mail system to send emails within organizations of an inventive hierarchical social network system for a given report category;

FIG. 8 is a schematic block diagram of a compilation of an event (synonymously detailed herein as a story or a briefing) that can be published by an inventive system user with appropriate permissions to announce a given event and aggregate data for reporting purposes from the aforementioned figures;

FIG. 9 is a schematic block diagram of a process by which a simple web page such as a wiki can be generated and edited within the hierarchical organization;

FIG. 10 is a schematic block diagram of task management flow within the inventive system;

FIG. 11 is a schematic block diagram illustrating file sharing data flow within the inventive system;

FIG. 12 is a schematic block diagram of information flow within the inventive system for the generation of reports as to information of value and best practices to users within a hierarchical organization;

FIG. 13 is a schematic block diagram of typical information flow for an internal messaging system operative in the inventive system;

FIG. 14 is a schematic view of the hardware and interactions therebetween according to the present invention;

FIG. 15 is an exemplary dashboard graphical interface of an inventive system; and

FIG. 16 is an exemplary group or user profile screen having application tabs that is reached via the dashboard of FIG. 15.

### DESCRIPTION OF THE PREFERRED EMBODIMENTS

The present invention has utility as a system composed of computer software, computer hardware, and network communication components that allows for a more efficient information flow within an organizational hierarchy that encourages bottom-up communication of actionable intelligence, top-down accountability, and the implementation of feedback loops within the hierarchical organization. The transparency imparted by an inventive system tends to motivate individuals with the organization as individual achievements become apparent to the organization as a whole and best practices are laterally shared among organizational individuals doing the same or similar types of jobs.

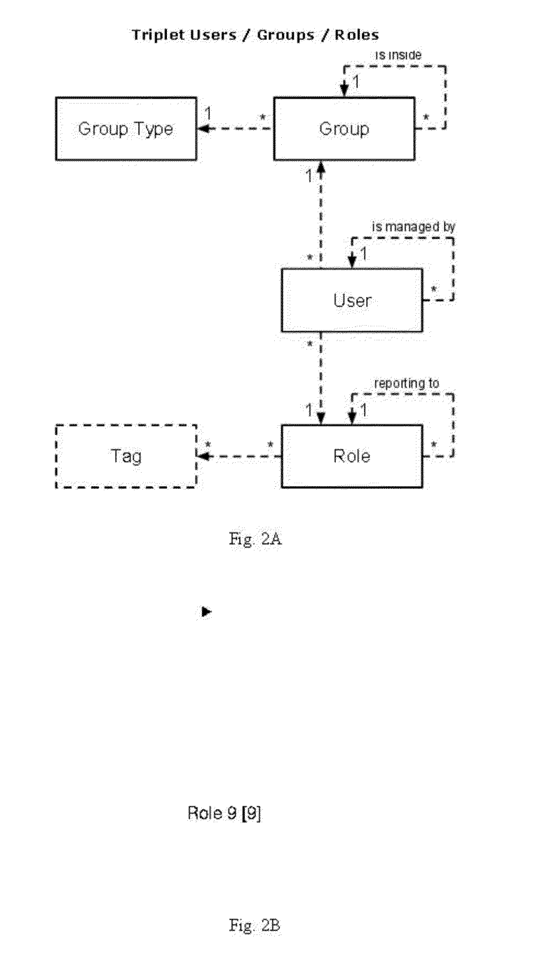

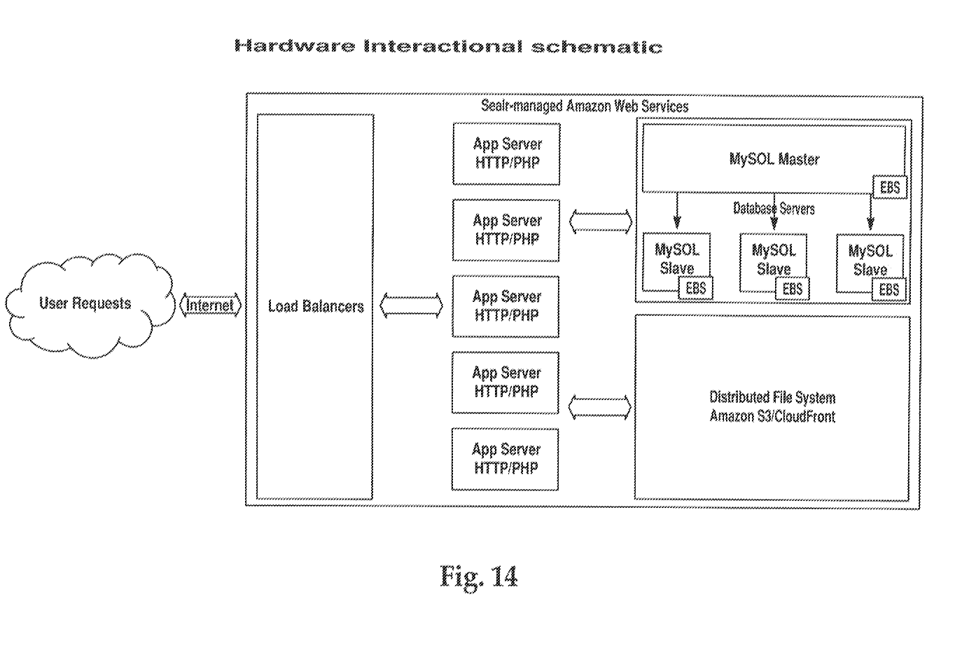

The present invention provides a social network in which an organizational hierarchy has a main group with at least one subgroup reporting to the main group and multiple field users that report to the first subgroup. The main group has at least one main group user and each of the subgroups has multiple subgroup users. A server receives field user messages from the field users and subgroup user messages from the subgroup users and communicates the field user messages and subgroup user messages to the main group user by way of a wireless device, such as a Smartphone, PC/desktop computer, or tablet based touch screen wireless devices. The value of the wireless device is that the main group user is in this way not tied to receiving information only at a secure computer terminal. A subgroup user (synonymously referred to herein as a “team member”, “organization manager”, “organizer”, “coordinator” or “leader”) receives messages from lesser role users within a subgroup user's subgroup and also from a lateral subgroup user so as to allow for the sharing of best practices between like situated subgroup users. Field users within the first subgroup, while able to input messages into the hierarchy, have restricted permission to receive messages from lateral field users within the subgroup unless specifically overridden as detailed with respect to FIGS. 2A-2D. The server employs preselected communications permissions for the organizational hierarchy for the main group user, the subgroup user, and the field user. The server stores the various messages and makes them available to various users based on preselected permissions associated with a given user for various uses which will be further detailed herein with respect to the figures. Preferably, the server stores the various messages and data in a cloud-based data storage. More preferably, information communicated to and from the server is communicated with encryption to inhibit unauthorized access to such communications. A hardware interactional schematic is shown in FIG. 14.

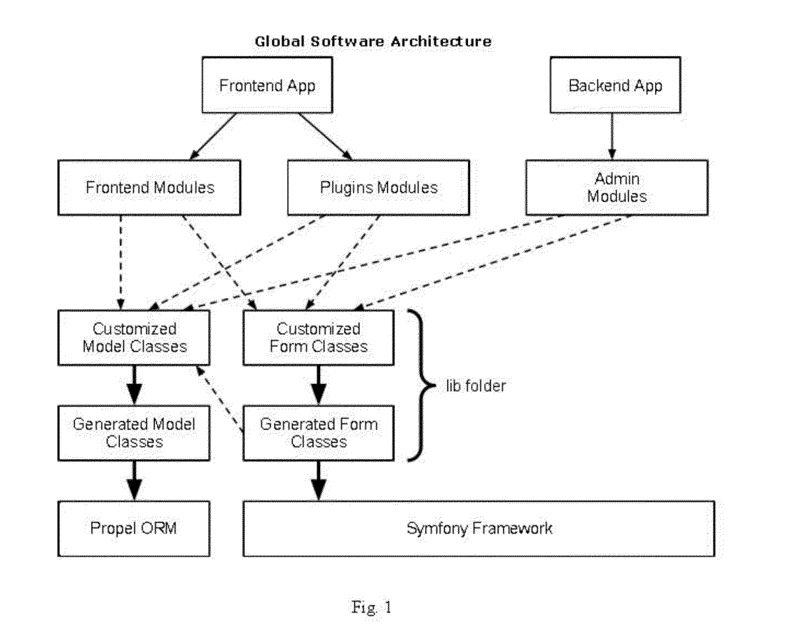

The present invention is further detailed with respect to the application figures where arrows denote communication directionality and lines denote interaction. A global software architecture for an inventive system is preferably built on conventional object-relational mapping (ORM) software and a web application framework such as Symfony. Representative ORM software is Propel 1.2. It is appreciated that other ORM software platforms are operative herein and illustratively include Doctrine. In addition to Symfony 1.2 as an exemplary framework for software associated with an inventive system, other versions of Symfony as well as other frameworks are operative herein, these other web application frameworks illustratively including Zend, CakePHP, CodeIgnitor, and PHP without a framework. With these software platforms in place, a library folder (synonymously detailed herein as “lib folder”) is created inclusive of customized model classes and form classes that are used to provide generated model classes and generated form classes, respectively. The interaction of these customized model classes with software applications (synonymously detailed herein as “apps”) relative to various modules are provided in FIG. 1.

Inventive global software architecture includes a front end app and a back end app. The front end app is experienced by an inventive user whereas the back end app largely involves administrative modules for the operation service and maintenance of the architecture. The front end app includes a variety of front end modules and plug in modules with the various modules interacting to produce customized model classes, customized form classes which each in turn generate model classes and form classes, respectively. This intermediate portion of the global software architecture represents the lib folder. As depicted in FIG. 1, the model classes are used in context of object-relational mapping software whereas the generated form classes operate on a web application framework that is provided in FIG. 1 in exemplary form as being symphony. It is appreciated that various apps and modules operative in FIG. 1 are commercially available. Additionally, documentation associated with platform ORM and Symfony framework software is publicly available common to freeware.

The present invention uses various forms of hierarchies that are customizable to a given organization. These types of hierarchies include a group hierarchy that corresponds illustratively to the geographical, specialty, or relational organization of groups. A user hierarchy represents people managing (subgroup users) and managed (field users) by each individual within an organization. A role hierarchy which defines the specific duties and responsibilities associated with a given user is also provided to map an individual user into the inventive network system based on geographic location, organizational position, and role, as seen in FIG. 2A. A tag table as denoted in FIG. 2A is used to create a role bundle to tag any information object provided to the server for subsequent routing and manipulation within the inventive system.

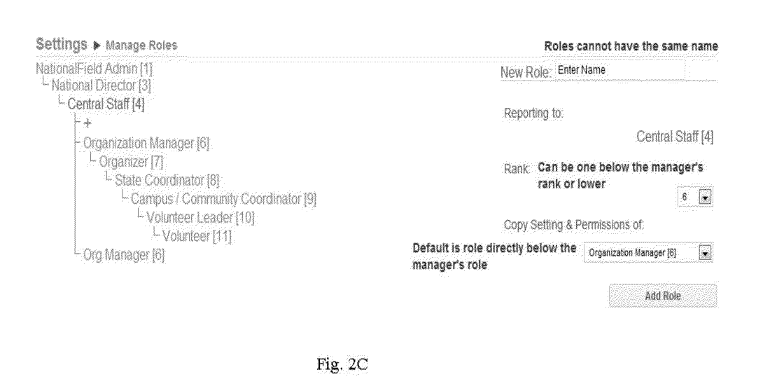

A critical difference between the present invention and prior art flat social network systems is the graded permissions associated with various users as for example as applied with respect to FIG. 2A such that all users are not treated equally but rather afforded permissions commensurate in scope with their role and position within the hierarchical organization. The present invention uses two different permission systems that include an action-based permission system as for example managed by the sfGuardPlugin of Symfony 1.2 based on the role attributes of a given individual and object-access based permissions which are managed on a case-by-case basis using group hierarchy position-role and preselected other conditions applied by the organization system owner. This action based permission based on the role played by an individual within the hierarchy is shown graphically in FIG. 3.

An administrative portion of an inventive system provides setting control for the management of various roles within an inventive hierarchy. As shown with respect to FIG. 2B, a series of roles are provided with ascending numerical values for a given role denoting lower status within the inventive hierarchy. This portion of inventive system software controls the permissions for a given member of the hierarchy regardless of whether the member is a field user, subgroup user or main group user with a number of such subgroup and field user roles being assigned a generic term of a numerical role. In many organizational embodiments of the present invention, and owing to the complexity of permissions associated with the various roles, appointment of various permissions and settings for a given role position within the hierarchy are set as defaults by an organization administrator denoted as numeral 1 and FIG. 2B. Optionally, permission to manage roles within a hierarchy is binary with users able to edit roles ranked beneath them within the hierarchy. It is appreciated that an inventive hierarchy need not be linear and instead include dendritic portions with each of the multiple dendritic branches being assigned a given set of permissions and a preassigned ranking. It is further appreciated that some more tasks within different branches of an organization are optionally assigned unequal rankings and therefore permissions within the hierarchy as dynamically assigned by a hierarchy administrator or someone superior to them within the hierarchy. Preferably, an aspect of an inventive hierarchical system is that roles with equal rank cannot manage one another.

As a user interface, an exemplary hierarchy is depicted in FIG. 2C in which under the role of central staff [4], a new role is created reporting directly to central staff 4 as denoted by the “+” symbol. After creating the position within the organization, as denoted in FIG. 2C, a title, name of individual, both are entered into the organizational hierarchy as well as assignment of a nominal numerical value denoting default permissions for the newly created user. In the example provided in FIG. 2C, it is noted that the newly created title can only be assigned a rank of five or greater. A new organizational manager is shown in FIG. 2C as being newly added and assigned a numerical ranking of six. This newly added manager as shown at the bottom of FIG. 2C is then able to fill an organizational hierarchy for the new branch directly or with the help of an administrator or someone higher within the organization in terms of numerical rankings. The new organizational manager denoted as “ORG Manager” is then able to assign hierarchical rankings of 7 and higher as individuals are added to the new branch.

To further customize and understand permissions for a given individual within a hierarchy, a representative user screen is depicted in FIG. 2D for role 9 as shown in FIG. 2B. The upper left hand corner of the user screen depicts a hierarchy of FIG. 2B showing a global position of role 9 within the organization while the upper right hand portion provides basics about role 9 with specific information as to whether the role 9 reports or not and if reporting the identity of the role 9 manager who in this case is team member denoted as rank 3. In the representative screen the image of FIG. 2D, two columns are provided for individual permissions that control a menu of possible permissions for the individual occupying role 9. Column 1 provides permissions inclusive of offsets that are instrumental in determining how much of the hierarchy is visible to the individual of role 9. By way of example, top offsets determine how many levels from the top the role 9 individual is able to see. By way of example, if the top offset of the group_date page is one, the role 9 individual will not be able to see the data tab of the main group but will be able to see the data tab of the group directly below the main group in their respective branch which in this case include the undefined role “+” and role 10. So exemplary of the descriptions provided for the various exemplary permissions provided in FIG. 2D is noted that a bottom offset control provides access as to how many levels below the role 9 individual can view. If the group_data is set to a bottom offset of zero, the role 9 individual can see the group data page for their group and below. Typically, bottom offset values have a role of zero. The bottom offset is particularly valuable as a control when similar responsibility individuals are assigned different numerical rankings within the group hierarchy thereby making top offsets difficult. The second column provided in FIG. 2D provides a series of binary permissions relating to the options the role 9 individual is able to see on a setting page of an inventive system. Preferably, permissions are automatically saved when modified with a confirmatory message appearing when permissions are disabled. It is appreciated that such messages are personally communicated to an administrator, an individual making the modifications, an individual in this case role 9 whose permissions have been modified, or a combination thereof.

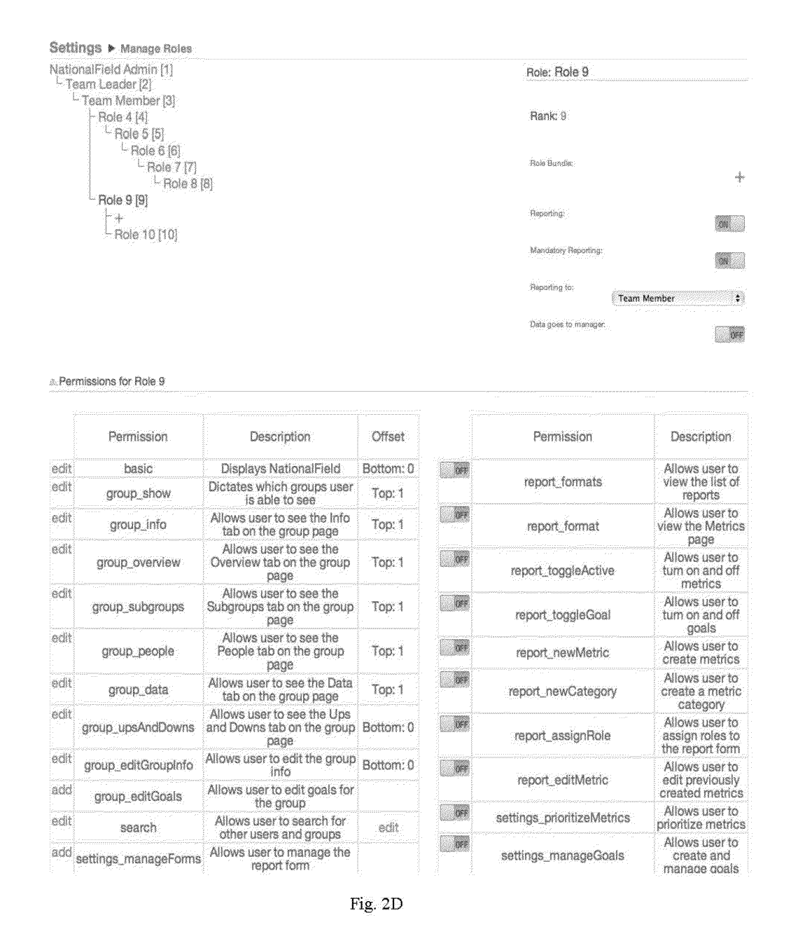

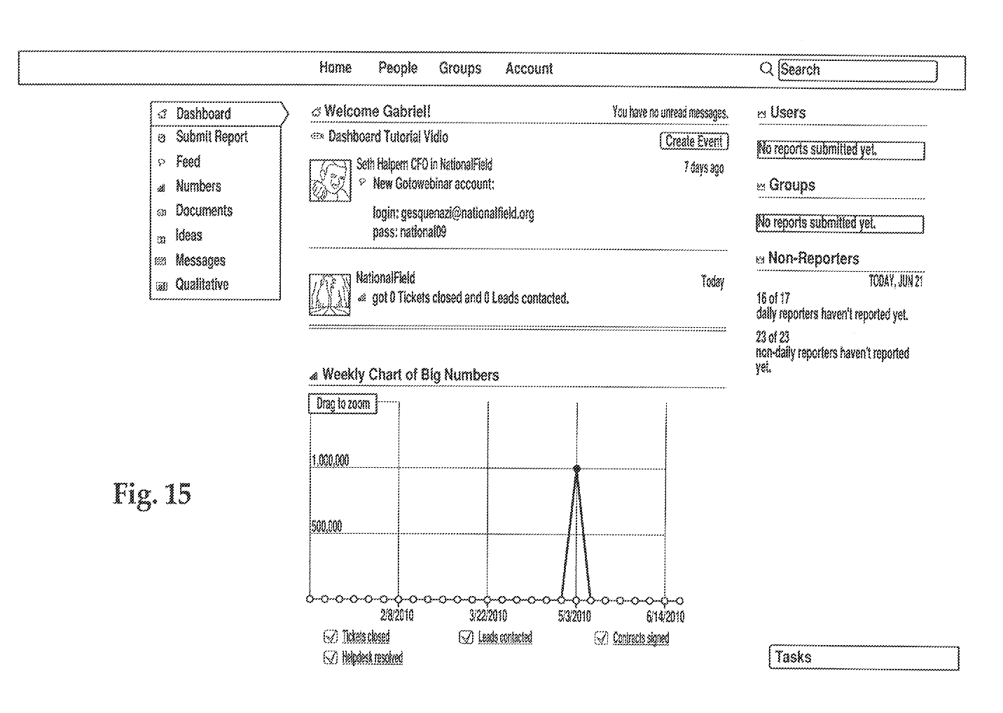

An inventive system allows for numerical metrics to be communicated to the server through a submit action report front end application that is accessed through a dashboard, as for example, depicted in FIG. 15. If a given field-, subgroup-, or main group-user has appropriate permissions, the aggregation of such metrics is displayed on a user/group data tab associated with the dashboard. To help in analysis of data, a user can optionally create a pseudometric through, for example, Microsoft Excel formulas, as for example might be calculated via PHP Excel based on the raw metric values. As shown in FIG. 4A, when a value is entered by a user, the value is categorized according to a particular metric and routed to an appropriate report category which in turn is formatted and optionally, directed to permissive groups or individuals with a role in the organization such that the metric and/or report is of value. The value is optionally entered directly or extracted from a response, the response itself optionally being routed to a permissive user.

The management of metrics and reports is provided to a user with an appropriate level of permission as shown in the exemplary screen page depicted in FIG. 4B. This computer user interface page provides a user with a quick overview of which forms are active and also allows a user to manage the questions which appear on the form. The bold annotations at the top of FIG. 4B highlight the ability of a user to edit questions and settings for a given form as well as the nature of the report and type of questions that are reported. A user also has the ability to select a binary on/off control whether a given attribute is active. Preferably, only a user who has created a form is afforded the ability to edit such a form, someone higher in the hierarchical rankings than the user, or a combination thereof. It is noted that the ability to selectively turn off a question, instead of removing the question from the questionnaire allows a user to retain previously entered information for the question. It is appreciated that a user need not turn off all of the questions in a given form, if the form itself is been turned off. Such an instance, when a form is turned off, and no longer appears where it was previously posted such as for example as part of a report on a profile page or the like; and it does not appear on the form section of a navigation box or profile page; however, such data already entered remains available for subsequent analysis.

In the event that a user would like to add or edit a question for a given form or modify the settings for the form, the user simply activates the “edit” link next to the name of the form thereby taking the computer interface screen to a create new form page that appears with questions and settings as previously entered. A user interface computer screen page is depicted in FIG. 4C for the creation of a new form. Some of FIG. 4C is annotated for illustrative purposes with bold arrows and texts affording further description as to data inputs and information that will appear in the resultant forms created.

The default view when creating or editing a form is provided in FIG. 4C where the user has an option to change the order of questions, the nature of the questions, whether answer of the questions is mandatory for completing a form, the type of response for a question and other exemplary attributes associated with a questionnaire. In preferred embodiment, a user can create forms for rankings above them within the hierarchy and more preferably only for rankings within their hierarchical branch. It is appreciated that permission to form or otherwise create forms for users is readily modified by an administrator so as to allow a user by way of example to only create forms for like situated ranked users, or users below them in ranking, across an entire hierarchy, or other options as dictated by a hierarchy administrator. An attribute of an inventive system is that it has been noted that hierarchy system users do not tend to abuse the ability to create forms for higher ranked users and thereby allowing the system to have open settings thereby affording greater flexibility and efficiencies for the system overall. Preferably, a creation of a form is divided into two sections as depicted in FIG. 4C namely development of questions and settings for the resultant form.

The second attribute of creating a form is provided in the exemplary screen provided to a user on a computer interface as a separate tab related to form settings. It is appreciated that information associated with settings is readily provided in the same page or in other delineations to achieve the end result of the creation of a new form. The settings for the form determines representative functional attributes of the form illustratively including such functional attributes as who within the hierarchical organization fills out the form, how often the form is to be completed, viewing privileges for the inputted responses, data extraction for statistical plotting and analysis, and the like. It is appreciated that a form is created in the context of an inventive system not only in the context of a report form but also in the context of a profile page, public survey, or a combination thereof. As a result, a form, for example, created as a profile page represents a way for users to add organization specific information thereby allowing the organization to retain all the forms and responses in a single unified system as opposed to using contract internet based survey services with which data sharing and permissions consistent with the inventive invention cannot be readily established.

According to the present invention preferably, when completion of a form is mandatory; as distinguished from the instance where completion of answers to questions is mandatory. In such instances, when a question is mandatory, the form cannot be submitted until the question has been answered, whereas a given form being mandatory can dictate the criticality of a given individual within the hierarchy submitting such information to the organization. By way of example, the completion of a mandatory form would appear at the end of a given report submitted to somebody of higher rank within the organization and also in the “my responses” section of the “forms” tab in the “navigation box”, as seen for example through user interface page 15 for a given role individual in the hierarchy.

The recurrence of a form per FIG. 4C pertains to forms added to a report page and dictates how often the form is reset for new responses. Typically, a user creates forms to reoccur on a periodic basis such as daily or weekly although, there are options for other time periods that they may preset or set for a user to choose. Optionally, a due date is provided for the last date that the form should appear. In a preferred embodiment, the due date when passed means that the form is still active and users can still view the responses in the form section. Such as when a form is recurring, the text changes to “next due date” thereby indicating that the form will refresh the day after the due date. By way of example, if a weekly form has a due date of Friday, the form will appear blank on Saturday for the response for the next recurrence due on the subsequent Friday. Optionally, and as depicted in FIG. 4D, hierarchical roles that complete the form and those which view the responses are divided into two sections as it is possible that a given role ranking is required to complete a form yet cannot view the responses so input. It is appreciated that this flexibility also benefits users higher in the organizational hierarchy who are able to see responses yet themselves are not required to complete a given form. According to the present invention, preferably forms are limited to a users ranking and below yet all roles are optionally added to a form such that hierarchical users are able to add roles above them so as to enable higher ranking individuals within the organization to view responses and not create forms for the whole organization.

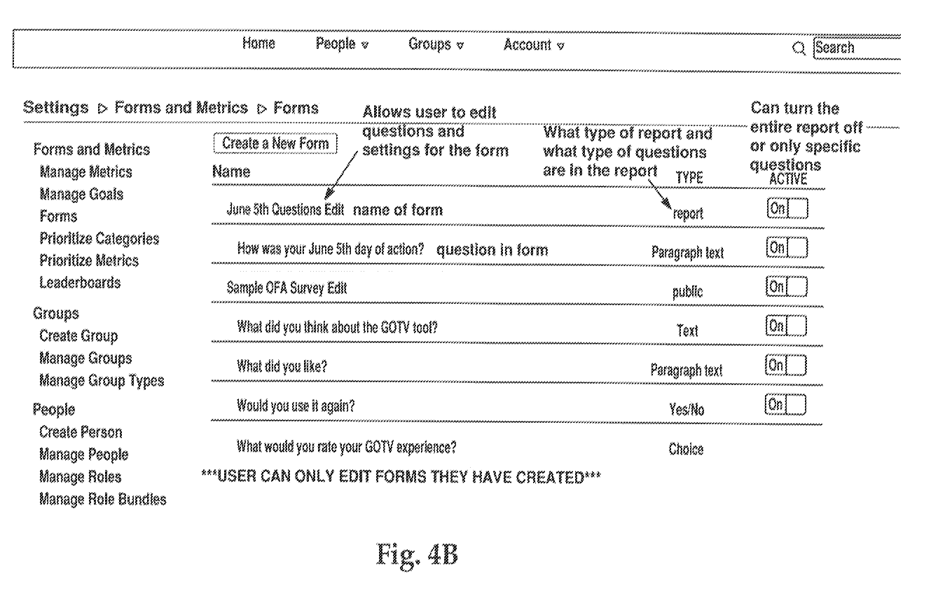

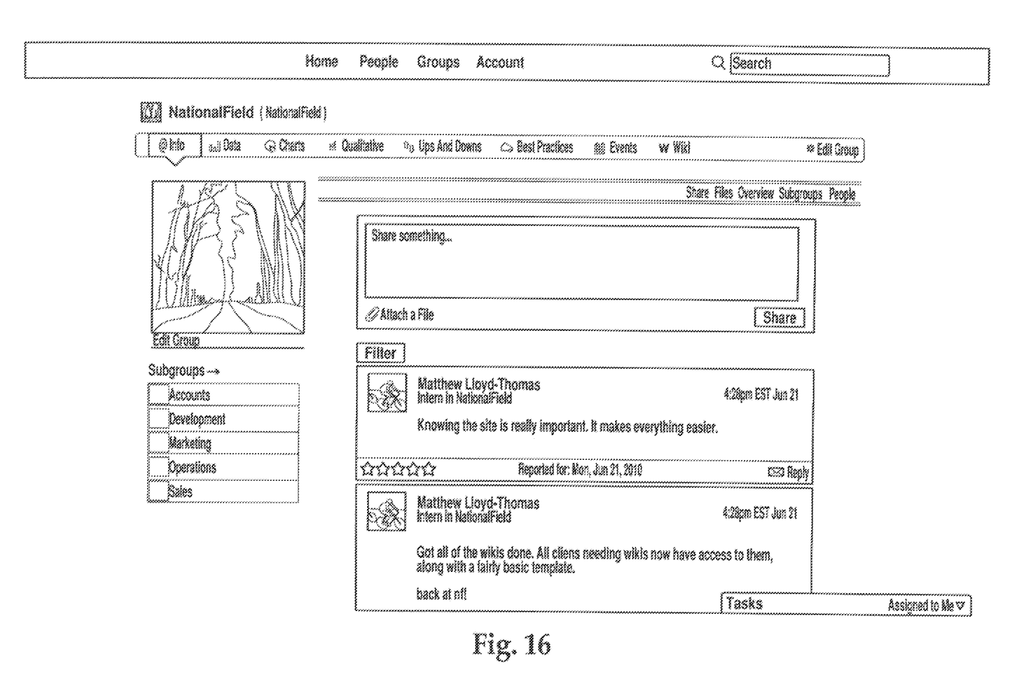

These dynamic forms are optionally provided to extract qualitative information from various reports generated through the completion of the forms of FIGS. 4A-4D. The extraction of qualitative data from a report is contained within the lib folder and tailored to customized form classes. By way of example, a given dynamic form (synonymously “dynform”) contains actions and components to manage the forms such as user report, settings, and the like as known, for example, from a group profile depicted in FIG. 16. A separate form contains the actions for data analysis and includes data tables and object notations such as, for example, JavaScript object notations that can be separately queried. A separate public access form is provided to facilitate public survey or other information input by an individual with no permissions relative to the inventive system. The permissions, settings editor, and form saving table rows are depicted graphically in FIG. 6. The optional communication of dynform and/or publication for a given group or role within the organization is also shown graphically in FIG. 6.

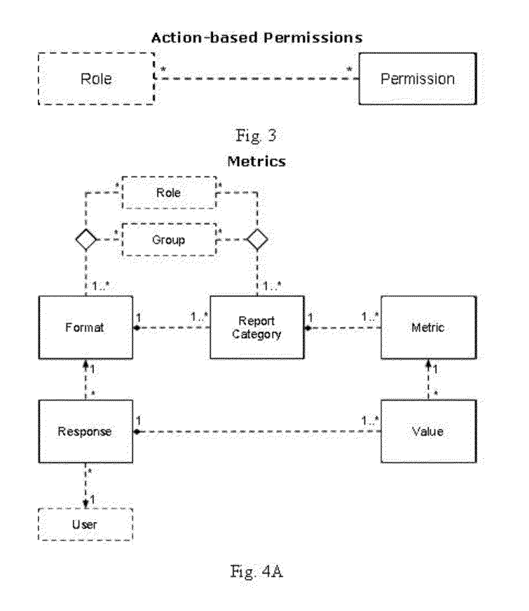

Based on input metrics or alternatively initiated de novo, an inventive system user can provide goals to organizational hierarchy subordinates; as depicted graphically in FIG. 5. The goal is provided for a given time period with the goal and the time period in which to achieve the goal optionally being transmitted to a given user within the organization while the period is optionally routed for integration into a given report category. Both the goal and the period for achieving the same are also optionally communicated for formatting purposes.

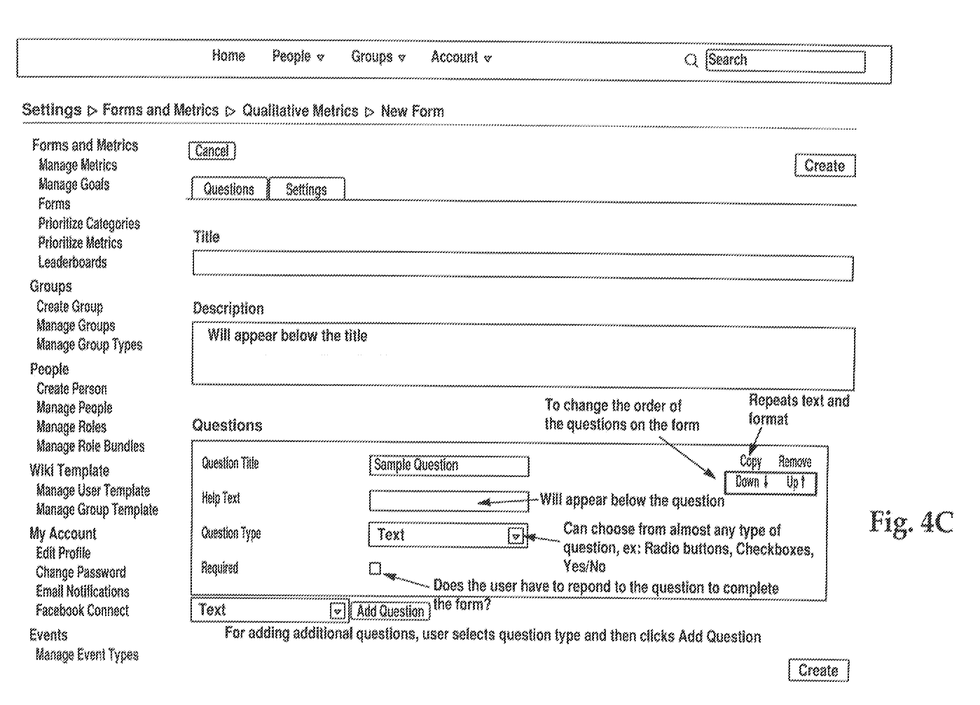

An inventive system also includes a largely conventional mail system designed to facilitate communication within an inventive system of the various users. The content and frequency of emails are provided in the template as shown in FIG. 7. A cron or other time based job scheduler operating on an Unix or other operating system, adds the emails to be sent to a queue and another sends emails scheduled in the queue and modifies their status to “sent”. Optionally, this queue information is sent to a given user based on permissivity while template material is optionally fed to a given report category for compilation with respect to a given report category as detailed with respect to FIG. 4 or 5 as detailed above.

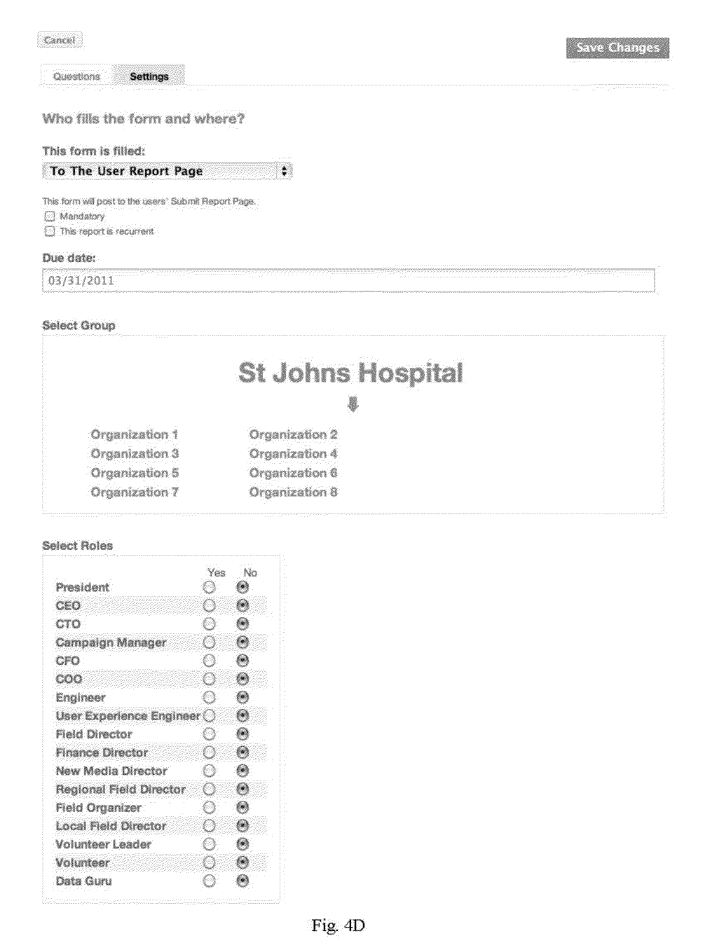

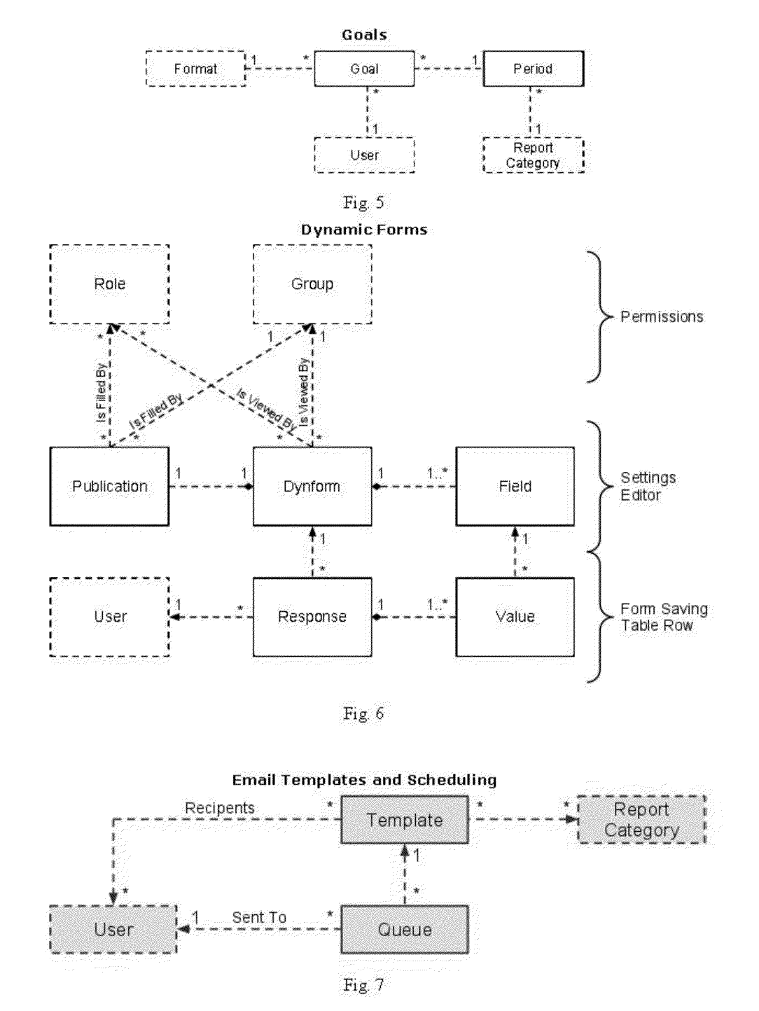

An events tab as seen in FIG. 16 allows for a story or briefing to be posted by any given user depicted in FIG. 8. The story is optionally communicated to a given user or group based on permissivity, as shown in FIG. 8. By analogy, a simple web based page such as a wiki page is generated and revised as shown in FIG. 9. A tab for a wiki page is evident on the group profile page of FIG. 16. As a way to describe similar groups, each group is assigned one or more “group types” to illustrate what type of group it is. Similarly, each user can be described to be like other users be defining the “user role”. Permissions are defined from the user's role and users of similar roles can be compared against one another. After the page is generated by a given user, the page is subjected to revision by the creating user or another user having appropriate permissions with revisions implicitly including the inclusion of additional content. A page once created is readily indexed and associated with a report category as detailed with respect to FIGS. 4 and 5.

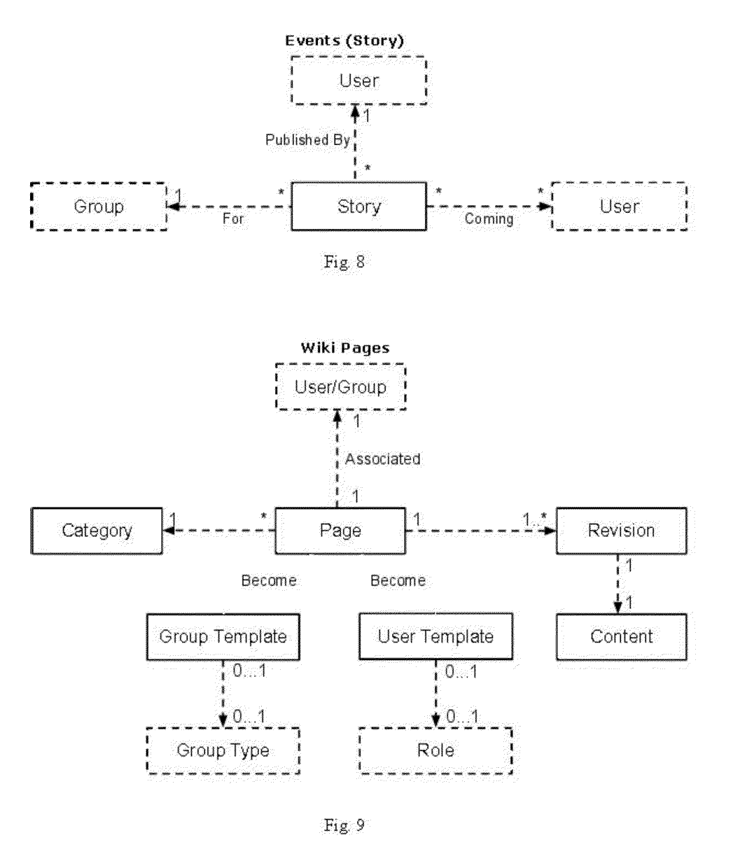

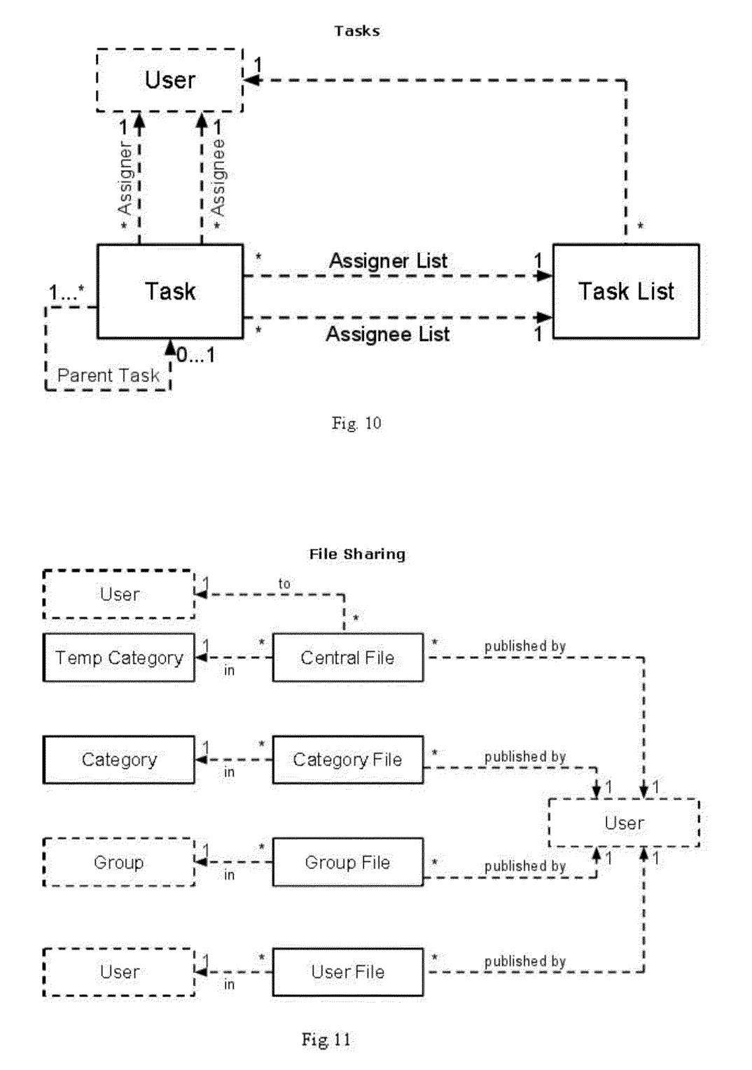

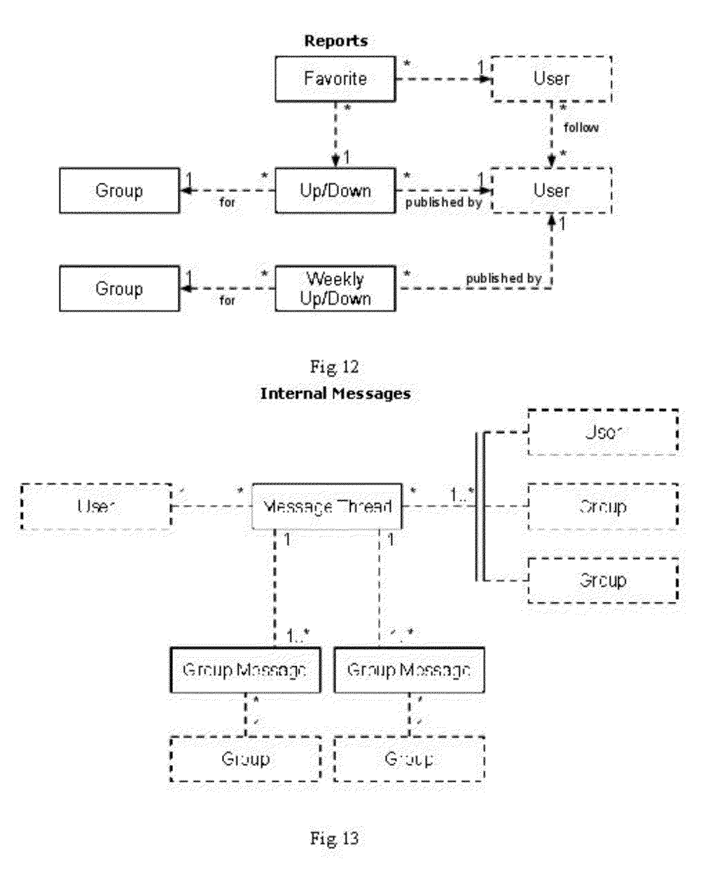

An inventive system also provides a task management function that allows a given user to assign tasks to other users within the organization. Exemplary of such a task is form completion as detailed with respect to FIGS. 4A-4D. Preferably, each task is tracked on two separate track lists with the first list for a task assignor and a second list for a task assignee. The information flow between a given user and a task list for a given task, as well as the optional presence of a parent task of which the task is a subset, are depicted graphically in FIG. 10. Users can access a central file repository where they are allowed to upload files and set permissions for each file. Files are grouped into folders. Each file and folder has role-based and hierarchy-based permissions. For example, a user in a top group may upload a file that all users in the organization who are of role A are able to retrieve and download. Another user may upload files that all roles are able to retrieve but only if they are in a subgroup. Ups and downs are a streamlined method for communicating private, short text-based messages up the hierarchy of an organization. These private messages are used to “push” intelligence from users within an organization to key decision makers throughout the organization's hierarchy who should see the intelligence. Best practices allow users within the organization's hierarchy to relay tactics and strategy that are effective to users who perform a similar role within the organization.

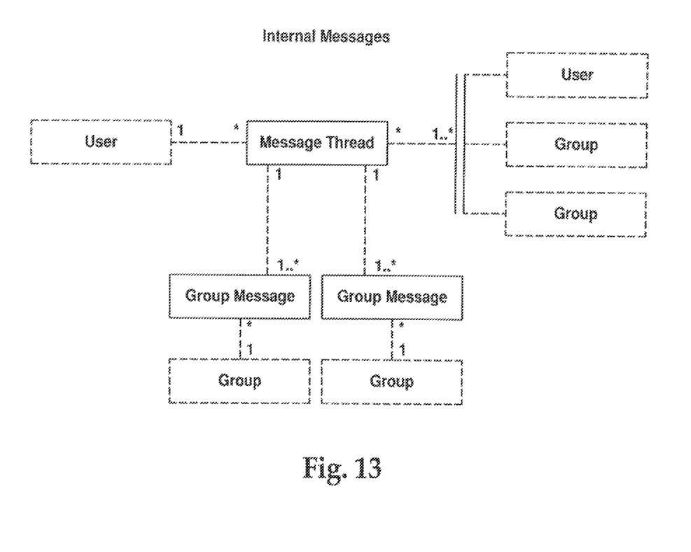

Optionally, an inventive system includes an internal messaging system that is otherwise conventional and allows a user to send messages to individual users, whole subgroups, and users with specific roles. Such an internal messaging system is depicted graphically in FIG. 13.

The foregoing description is illustrative of particular embodiments of the invention, but is not meant to be a limitation upon the practice thereof. The following claims, including all equivalents thereof, are intended to define the scope of the invention.

1. A social network system comprising:
an organization hierarchy having a main group, at least one subgroup reporting to the main group, and a plurality of field users reporting to a first subgroup of the at least one subgroup, the main group having at least one main group user and the at least one subgroup having a plurality of subgroup users;
a server receiving field user messages from the plurality of field users and subgroup user messages from the plurality of subgroup users, said server communicating the field user messages and the subgroup user messages to a main group user wireless device associated with a specific main group user from among the at least one main group user, said server communicating the field user messages from the first subgroup and the subgroup user messages to a first subgroup user wireless device associated with one of the plurality of subgroup users, said server communicating the field user messages to a field user wireless device associated with one of the plurality of field users within the first subgroup, said server employing preselected communication permissions for the organization hierarchy that are different for each of the main group user wireless device, the first subgroup user wireless device, and the field user wireless device, said server storing the field user messages and subgroup user messages.

2. The system of claim 1 wherein said server storing the field user messages and subgroup user messages is a CloudBase data storage and communicating the field user messages and the subgroup user messages with encryption.

3. The system of claim 1 further comprising software operating on said server and activated by one of the at least one main group user or the plurality of subgroup users to provide an actionable goal to one of the field user wireless device or the first subgroup user wireless device.

4. The system of claim 1 wherein said server assigns to each individual within the organizational hierarchy a position within a group hierarchy, an organizational hierarchy, and a role hierarchy.

5. The system of claim 4 further comprising software for editing permission for the individual based on role hierarchy.

6. The system of claim 4 wherein the field user messages comprise metrics that are parsed into report categories for aggregation with a second metric provided through a second field user message.

7. The system of claim 5 further comprising a dynamic forms software application able to collect qualitative information from the field user messages, the subgroup user messages, or a combination thereof.

8. The system of claim 7 wherein a member of the organizational hierarchy has permission to request completion of a form produced by said dynamic forms software by others of lower status in a same branch of the organizational hierarchy relative to said member.

9. The system of claim 6 further comprising an additional application that provides at least one of the following: email, event publication, wiki pages, file sharing, or internal messaging within the organizational hierarchy.

10. The system of claim 7 further comprising a software dashboard on each of the main group user wireless device, the subgroup user wireless device, and the field user wireless device operating as an interface for communication with said server.

11. The system of claim 10 wherein said dashboard is linked to a tabbed group/user profile software page.

12. A process of generating compiled graphical output of data comprising:
setting up an organizational hierarchy having a main group, at least one subgroup reporting to the main group, and a plurality of field users reporting to a first subgroup of the at least one subgroup, the main group having at least one main group user and the at least one subgroup having a plurality of subgroup users;
said plurality of field users inputting at least one field user datum of the data, said member of said plurality of field users lacking permission to access the data other than the at least one field user datum, the at least one field user datum being communicated through a field user wireless device to a server;
allowing at least one of the said plurality of subgroup users for said at least one main group user to view the compiled graphical output of data on a secure subgroup user wireless device or a secure main group user wireless device.

13. The process of claim 12 wherein the inputting is through a form generated by Dynamic Forms software.

14. The process of claim 13 wherein said form is editable based on preselected permission by the at least one main group user or one of said plurality of said group users.

15. The process of claim 12 wherein the compiled graphical output of data is viewed in real time.

16. The process of claim 12 wherein the inputting is periodically recurrent for a preselected reporting period.
